(19) United States
(12) Patent Application Publication
(10) Pub. No.: US 2013/0209750 A1
(43) Pub. Date: Aug. 15, 2013

(54) METHOD AND APPARATUS FOR FORMING CORRUGATED BOARD

(71) Applicant: Patrick Petrus Antonius Maria Van Berlo, Hamilton (NZ)

(72) Inventor: Patrick Petrus Antonius Maria Van Berlo, Hamilton (NZ)

(73) Assignee: CORCEL IP LIMITED, Hamilton (NZ)

(21) Appl. No.: 13/637,723

(22) PCT Filed: Mar. 31, 2011
(86) PCT No.: PCT/NZ2011/000044

§ 371 Date: Dec. 4, 2012

(30) Foreign Application Priority Data
Mar. 31, 2010 (NZ) 584362

(51) Int. Cl. B32B 37/00; B32B 3/28

(52) U.S. Cl. CPC B32B 37/0076; B32B 3/28
USPC 428/174; 156/292; 156/580; 524/563

(57) ABSTRACT

A method is provided for bonding a substantially planar sheet material to a corrugated sheet material, both of which are porous using a continuous process, the method including:
a) applying a controlled amount of adhesive to an apex contact portion of the corrugated sheet material; and
b) holding the respective planar and corrugated sheets together at a specified pressure and for a specified pressing period so that a bond is formed between them.

### TECHNICAL FIELD

The present invention relates to an improved method and apparatus for forming corrugated board. In particular the present invention discloses a method and apparatus for manufacturing single face corrugated board and/or, in some embodiments, double face corrugated board.

### BACKGROUND ART

For ease of reference only, the present invention will now be described in relation to the production of single face paper board although this should not be seen as limiting as certain embodiments of the present invention can be used to produce double face corrugated board.

As used throughout this specification the terms corrugated and fluted and grammatical variants thereof are used interchangeably and refer to a series of alternate ridges (crests) and grooves (troughs).

Single face corrugated paper board is very well known and is used extensively in industry, especially in packaging where it is used as protective padding and wrapping. It is also used as a basic component in the production of standard cardboard (i.e. double face corrugated board) and many structural objects such as boxes, panels, pallets etc.

Sheets of single face corrugated paper board can be bonded together to form multilayer corrugated paper boards of various thicknesses and strengths. One reason for the wide use of corrugated paper board is its relative light weight, rigidity and strength.

Single face corrugated paper board is made by bonding a fluted sheet material (generally recycled paper) paper, onto a liner sheet. The liner sheet is typically Kraft paper although other materials may be used.

In a conventional machine for producing single face corrugated (aka fluted) paper board, the fluted sheet is formed by passing a sheet of paper between two corrugating rollers. The two rollers are arranged such that there is an inter-meshing of the teeth at the periphery of each roller. A sheet of paper is fed between the teeth of the rollers which forces the paper into flutes as the teeth of the rollers intermesh. The fluted sheet is held in contact with the teeth on the periphery of one of the corrugating rollers, typically by a vacuum formed within the corrugating cylinder, at least until the liner is added.

A line of adhesive is applied to the crests of the flutes to bond the liner to the fluted paper. A sheet of liner paper is typically pressed onto the crests by a smooth roller so as to bond the liner with the fluted paper thereby forming a single face corrugated (or fluted) board.

A limiting factor in this process is the requirement to maintain contact between the fluted sheet and the liner for sufficient time for the adhesive to set and a bond to be formed. This time can be several seconds or longer at normal room temperatures and pressures. However, the time has traditionally been reduced by raising the temperature during the bonding process and by applying pressure to the join between the crest and the liner.

High pressure steam is commonly used to heat the cylinders over which the fluted paper and liner paper move, raising the temperature of the paper. Typical operating temperatures for the corrugating rollers can be around 150-200° C.

Pressure can be applied to the joint between the liner and each crest by a pressure roller arranged to press the liner against the adhesive covered crest. As the contact time between the pressure roller and corrugating roller (which holds the fluted sheet) is relatively short, high pressures are generally required in order to materially speed up the bonding process.

With this type of arrangement (heating plus high pressure) the bonding time can be reduced to a few hundredths of a second, allowing high speed production of single face paper board. However, one problem with this arrangement is that the high pressure exerted by the pressure roller can distort the paper and leave unsightly marks on the surface of the liner paper, reducing its value.

Some machines are other devices, such as endless belts, to press the liner and fluted sheets together as they move around the corrugating roller. As this extends the period of time pressure is applied, lower pressures can be used so as not to deform the surface of the paper board.

A typical arrangement of an apparatus to produce single face paper board generally as described above is disclosed in U.S. Pat. No. 5,951,817 (Thomas).

The machinery depicted in U.S. Pat. No. 5,951,817 has a limited contact time (and hence bond time) between the fluted sheet and the liner—as evidenced by the fluted sheet/liner combination only being in contact with a third of the circumference of the corrugated wheel. Such limited contact time requires the use of a fast drying adhesive such as a starch based glue typically used in the industry. Unfortunately, starch based glues require the application of heat (in the order of 150° C. or so) to activate. This leads to disadvantages as discussed below.

Although the use of heat can shorten the time required to form a bond between the fluted sheet and the liner, thereby facilitating high through-put, it does introduce a number of engineering issues which significantly increase the cost of the machinery and the operating costs for the process. The use of high pressure steam requires boilers, pipe work and housing to ensure containment of the steam at all times. There is a need for additional safety measures to ensure that the steam is produced and managed correctly and that the heat produced does not provide a safety hazard during operation of the machine. Typically a heating engineer is required to operate the boiler and maintain the heating system, adding the cost of additional skilled labour, as well as potentially stopping production if an appropriately qualified engineer is not available.

The addition of a high pressure steam system to the basic elements of the machine inevitably leads to an increase in the size of the machine and therefore the space required for operation of the machine. The requirement for more space adds to the operating costs for production of the single face fluted board.

Furthermore high pressure steam is very corrosive to many materials, and those parts of the machine exposed to the steam, for example the corrugating rollers, need to be made from corrosion resistant materials. Such materials, for example alloy steel 48 CrMo hardened to HRC 58-62 standard, are generally expensive and heavy. An apparatus made from such materials can require a substantial support structure to maintain the structural integrity of the machine.

A problem with both methods of applying pressure (roller and belt) is that the applied pressure can spread some of the adhesive away from the contact line between the liner and the crest of the fluted sheet, thus wetting the surrounding paper. Adhesive which is spread away from the crest (i.e. the contact line) will not dry quickly as adhesive along the crest as it is not under pressure, and typically it is not forming a bond between two sheets of material. As a consequence the superfluous (spread) adhesive remains wet for longer which can lead to problems of the paper board deforming as it dries at an uneven rate, and being difficult to cut or process further until it is fully dry. A common solution is to apply additional heating to dry out the paper and superfluous (spread) adhesive. However, this adds to the cost of production and may limit the speed of the process.

The spread adhesive can also get transferred to the surface of the device applying the pressure (e.g. the roller or belt) requiring that surface to be continually cleaned. Furthermore, some of the spread adhesive can be transferred to the outer surface of the liner, which can cause problems during storage when rolled, as neighbouring sheets can stick together making the product unusable. In addition, the excess spread adhesive can mark the surface, adversely affecting the appearance and the value of the corrugated board.

A further disadvantage with conventional machines is that typically both the feed rollers (used to feed the paper onto the corrugating rollers whether to be fluted or used as a liner) and the corrugating rollers, are heated in order to dry out the paper prior to addition of the adhesive. This is done to reduce the moisture content of the paper and to decrease the bonding time. The production of high pressure steam to heat the corrugating rollers and to pre-heat the paper can require a significant amount of energy. All of the above factors can add significantly to the cost of single face corrugated board made by conventional processes and machines.

The applicant has previously addressed many of these issues in its PCT Application WO2009/145642. However, it would also be useful if there could be provided a method and formula which can be used to:
manipulate configuration of the machine; and/or
accurately predict the speed of manufacture;
   when utilising a cold process for the manufacture of corrugated sheet material.

In particular it would be useful if there could be provided a method of manufacture which is optimised.

Previously, in WO2009/145642 the applicant thought that the rate of production was determined by the diameter and rotation speed of the second (larger) corrugating roller. The applicant also thought the fact the endless belt extended around three quarters of the second corrugating roller fixed the rotation speed at around 20 revolutions a minute. The applicant mentioning that for a second corrugating roller having a diameter of 1.6 m the rate of production was around 100 m/min of single face paper board.

However, it soon became apparent the above rate of production was at best a rough and ready rule of thumb and a more accurate rate of production formula was necessary prior to constructing a machine for producing single face board—to ensure the machine could meet expected demand. The need for a more accurate rate of production formula was particularly so given the time, expense and costs involved with building a corrugating apparatus. It would be useful if there could provided a more accurate way of determining, in advance, the rate of production.

Presently, due to the heat used in producing corrugated sheet material it is not possible to bond pre-printed sheet material directly to the corrugated sheet material as the heat damages the print.

Therefore, typically flexographic rubber printing stereos are used to apply print but given these require pressure to apply ink to the liner bonded to the corrugated sheet material this damages the flutes of the corrugated sheet material. As the flutes become slightly crushed by the flexographic rubber printing stereos this reduces the strength (i.e. structural integrity) of the board. In addition, the ink rollers can only produce a low quality print on the board—such as may be seen on many apple or other fruit boxes.

It would therefore be useful if there could be provided a way for applying pre-printed sheet material directly to the corrugated sheet material as part of a continuous in-line process for the manufacture of single face or double face board. In particular a method which allows the pre-printed sheet to form the liner would be an advantage as it reduces the amount of material and manufacturing steps and time required to produce boxes or other promotional material from corrugated board.

A further problem with conventional corrugators is that:
the application of heat to the paper; combined with
the continuous adjusted braking force applied to the paper coming off the reel stand to keep its path straight;
   all result in corrugated board being produced which curls at the corners and is thus not a dead flat sheet (as observed with the naked eye) which would be a higher value end product with no wastage.

Continuous braking is required because the paper as it is wound onto the reel at the pulp and paper factory, is subjected to left and right tensional forces, which cause the paper to deviate from a straight path when it is unwound off the reel.

it is an object of the present invention to address the foregoing problems or at least to provide the public with a useful choice.

All references, including any patents or patent applications cited in this specification are hereby incorporated by reference. No admission is made that any reference constitutes prior art. The discussion of the references states what their authors assert, and the applicant reserves the right to challenge the accuracy and pertinency of the cited documents. It will be clearly understood that, although a number of prior art publications may be referred to herein, this reference does not constitute an admission that any of these documents form part of the common general knowledge in the art in New Zealand or in any other country.

It is acknowledged that the term ‘comprise’ may, be attributed with either an exclusive or an inclusive meaning, depending on the jurisdiction. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

Further aspects and advantages of the present invention will become apparent from the ensuing description which is given by way of example only

### DISCLOSURE OF INVENTION

The term ‘continuous process’ as used herein refers to a process in which the corrugated sheet material can be bonded to the planar sheet material immediately following the formation of the corrugated sheet material by the intermeshing of the large and smaller corrugating rollers imparting flutes to a previously planar sheet material so as to enable the production of single face board by a single continuous (i.e. uninterrupted) process.

According to one aspect of the present invention there is provided a method of bonding a substantially planar sheet material to a corrugated sheet material both of which are porous using a continuous process, the method characterised by the steps of:
a) applying a controlled amount of adhesive to the apex contact portion of the corrugated sheet material; and
b) holding the respective planar and corrugated sheets together at a specified pressure and for a specified pressing period so that a bond is formed between them.

Preferably, steps a) and b) are undertaken at an ambient temperature.

In some preferred embodiments the adhesive is applied and sets at an ambient temperature. In other embodiments the adhesive may be heated prior to application (depending on the nature of the adhesive used) but in all such embodiments the adhesive selected must be such that it will set at an ambient temperature.

The term ‘apex contact portion’ as used to herein refers to the top part of the crest of a flute on a corrugated sheet of material which becomes pressed into abutment with the planar sheet at step b) of the process. The apex contact portion includes the apex of the crests and that region on either side thereof which will become pressed into direct contact with, and then bonded, by the spread of adhesive, to the planar (liner) sheet. The inventor has found that significant problems occur if the adhesive extends beyond the apex contact portion onto the sides of the corrugations. Such problems include:
increased bond time as the porosity of the liner cannot absorb the moisture in the adhesive outside the apex contact portion;
wastage of adhesive;
dimpling of the flutes;
curling of the board if the single face board is used to produce double face board.

Preferably, the specified pressure is as high as possible without compromising the integrity of the paper. In preferred embodiments the specified pressure is less than the tear strength of the porous sheet materials selected. The inventor has found that the higher the specified pressure the quicker the bond time.

The porous sheet material may generally be paper but can include other sheet materials with similar characteristics making it suitable for forming corrugated board. A key characteristic of the sheet material is that the porosity is sufficient to absorb substantially most of the moisture in the adhesive at the specified pressure.

According to another aspect of the present invention there is provided a method of bonding a substantially planar porous sheet material to a corrugated porous sheet material using a continuous process substantially as described above wherein the speed of production has been calculated by the formula:

RP=DHT/BT

wherein RP is the rate of production in metres/minute; DHT is the distance in metres for which the two respective sheets are held together; and BT is the bond time of the adhesive in minutes.

According to another aspect of the present invention there is provided a method of manufacturing an apparatus having a large and small intermeshing corrugating rollers for continuously producing a single face porous sheet material comprising the step of using the formula:

RP=DHT/BT

to determine the diameter of the large corrugating roller and percentage of the circumference of the large corrugating roller about which an endless belt assembly needs to apply pressure so as to achieve the desired rate of production;
wherein RP is the rate of production in metres/minute; DHT is the distance in metres for which the two respective sheets are held together; and BT is the bond time of the adhesive in minutes.

According to another aspect of the present invention there is provided an apparatus which bonds substantially planar porous sheet material to corrugated porous sheet material, to produce a single face corrugated porous sheet material as part of a continuous process which utilises a large corrugating roller and a smaller corrugator roller and glue applicator assembly together with an endless tensioned belt, wherein the rate of production of the apparatus has been determined by the formula:

RP=DHT/BT

wherein RP is the rate of production in metres/minute; DHT is the distance in metres the two respective sheets are held together; and BT is the bond time of the adhesive in minutes.

The term ‘specified pressing period’ as used herein refers to the bond time (BT) calculated by the formula:

BT=DHT/RP

wherein RP is the rate of production in metres/minute and DHT is the distance in metres the two respective sheets are held together.

If the apparatus of the present invention includes a larger diameter corrugating roller intermeshing with a smaller diameter corrugating roller then the value of the DHT is defined by DHT=X·(π2r) wherein r is the radius of the larger corrugating roller, and wherein X is the percentage of the circumference C of the large corrugating roller about which the belt of the endless tensioned belt assembly can apply pressure whilst leaving sufficient room for the glue applicator assembly and smaller corrugating roller. The maximum values of X increase with increasing diameter of the larger corrugating roller as outlined further below.

The terms ‘large roller’, ‘large diameter corrugating roller’ or ‘large diameter intermeshing corrugating roller’ or the like as used herein are interchangeable and refer to a corrugating roller that has a diameter which is at least twice the diameter of the ‘smaller diameter roller’, ‘smaller diameter corrugating roller’ or ‘smaller diameter intermeshing corrugating roller’.

According to another aspect of the present invention there is provided an apparatus which bonds a substantially planar porous sheet material to a corrugated porous sheet material, to produce a single face corrugated porous sheet material via a continuous process, wherein the apparatus includes a large diameter corrugating roller intermeshing with a smaller diameter corrugating roller, and an endless tensioned belt assembly arranged to apply pressure over the circumferential surface of the large corrugating roller to facilitate lamination of the planar and corrugated sheets wherein the circumference of the large diameter corrugating roller about which the endless belt can apply tension is governed by the formula:

C=(RP·BT)/X

wherein C is the circumference of the roller (i.e. π2r); RP is the rate of production in metres/minute and BT is the bond time in minutes; and X is maximum percentage of the circumference about which pressure can be applied by the endless tensioned belt.

According to another aspect of the present invention there is provided an apparatus which bonds a substantially planar porous sheet material to a corrugated porous sheet material to form single face corrugated porous sheet material via a continuous process wherein the apparatus includes a large diameter corrugating roller intermeshing with a smaller diameter corrugating roller, and a endless tensioned belt assembly which includes a tensioned belt arranged to apply pressure over the circumference of the large corrugating roller to facilitate lamination of the planar and corrugated sheets wherein the percentage of the circumference of the large corrugating roller which does not have the tensioned belt applying pressure thereto is limited solely by the minimum relative space required for the smaller corrugating roller and glue applicator assembly.

The inventor has now discovered that rather than the rpm of the corrugating roller the rate limiting factor is actually defined by the formula:

RP=DHT/BT

wherein RP is the rate of production in metres/minute; DHT is the distance in metres the two respective sheets are held together; and BT is the bond time in minutes.

Preferably, the belt assembly is configured so the belt can apply pressure over 70%-93% of the circumference of the large corrugating roller.

In preferred embodiments, the inventor has found the diameter of the large corrugating roller which can range substantially anywhere from 0.4 m-2.0 m determines the maximum percentage that the endless belt is able to extend around the circumference of the largest corrugating roller, whilst leaving room for:
glue application equipment which includes a glue roller; and
the smaller corrugating roller.

For example, for a 0.4 m diameter large roller the maximum percentage the endless belt can extend around the periphery of the large roller is substantially 70%, and for a 2 m diameter large roller the maximum percentage the endless belt can extend around the large roller is substantially 93%.

The inventor has found the average circumferential distance of the large roller required to provide room for the glue roller and smaller corrugating roller embodiment mentioned above may be substantially in the order of 0.45 m-0.5 m.

In a preferred embodiment the large corrugating roller may have a diameter of substantially 0.62 m and the endless belt applies a pressure around 76% of the circumference of the large roller.

In another embodiment the large corrugating roller may have a diameter of 2 m and the endless belt applies a pressure around 93% about the circumference thereof.

According to a further aspect of the present invention there is a method of operating a large diameter corrugating roller intermeshing with a smaller diameter corrugating roller and an endless tensioned belt comprising a pressing step in which the tensioned belt is arranged to apply pressure over a portion of the circumferential surface of the large corrugating roller to form an adhesive bond between a substantially planar porous sheet material and a corrugated porous sheet material comprising the further step of using the percentage of belt span about the circumference of a larger corrugating roller to determine the rate of production.

According to a still further aspect of the present invention there is provided a method of using a tensioned belt and a large diameter corrugating roller intermeshing with a smaller diameter corrugating roller and glue applicator assembly to produce single face corrugated board from a porous planar sheet material and planar corrugated sheet material, the method comprising the step of applying an adhesive to the corrugated sheet material, at an ambient temperature, and then holding the respective planar and corrugated sheets together via the tensioned belt, for a specified period of time.

The inventor has discovered the maximum rate of production of an apparatus which includes large diameter and smaller diameter intermeshing corrugating rollers is governed by the formula:

RP=X(π2r)·BT

wherein RP is the rate of production in metres/minute and BT is the bond time in minutes and X is the percentage of the circumference of the large corrugating roller about which pressure is applied by the endless tensioned belt.

An apparatus for manufacturing single face corrugated board from porous sheet material wherein the apparatus operates at a maximum rate of production determined by the formula:

RP=X(π2r)·BT

wherein RP is the rate of production in metres/minute, BT is the bond time in minutes, and X is the percentage of the circumference of the large corrugating roller about which pressure can be applied by the endless tensioned belt.

A method which utilises a large corrugating roller and an endless tensioned belt wherein the maximum rate of production is determined by the formula:

RP=X(π2r)·BT

wherein RP is the rate of production in metres/minute, BT is the bond time in minutes, and X is the percentage of the circumference of the large corrugating roller about which pressure is applied by the endless tensioned belt.

By way of explanation only the above formula for the maximum rate of production for intermeshing large and smaller diameter corrugating rollers is calculated by circumference of the roller (i.e. π2 r) multiplied by X being the percentage of the circumference about which pressure is capable of being applied by the endless tensioned belt; which is multiplied by BT.

In a preferred embodiment RP is substantially in the range of at least 25 m/min-200 m/min.

In a preferred embodiment the sheet material is Kraft paper.

Kraft paper is commonly used in the formation of single face corrugated board. However, as mentioned above, other porous sheet materials may be used with the present invention and therefore reference throughout this specification to sheet material being Kraft paper should not be seen as limiting.

The planar sheet material known as a liner may also be made from Kraft paper.

Reference to the term “substantially planar” should be understood to refer to a sheet or web having a substantially flat surface, in which lies with a single plane (at least when viewed with the naked eye).

In contrast reference to the term “corrugated” should be understood to refer to a sheet or web in which the surface is configured into a series of alternating crests and troughs (i.e. corrugations).

The corrugations in a corrugated sheet used to form a single face corrugated paper board are commonly referred to as flutes. Flutes are typically formed by passing a sheet of Kraft paper through a pair of corrugating rollers set in relation to one another so that the teeth of the corrugating rollers intermesh-on either side of the Kraft paper. The shape of the resulting flute is dependent on the shape and size of the teeth on the corrugating rolls. For example, (without limitation) a flute can be triangular, sinusoidal, trapezoidal, saw-tooth, rhombic, square or any other suitable repeating undulating shape. Similarly, the size of the flute is determined by the equi-size of the teeth and may be varied depending on the end application for the single face corrugated board.

In a preferred embodiment the corrugated sheet material has flutes with a substantially triangular sectional profile.

An advantage of having a substantially triangular sectional profile flutes is that this profile is relatively simple to form using conventionally formed teeth on the corrugating rollers.

Furthermore triangular shaped flutes may have added strength in comparison to some of the other shapes, particular against compression along the length of a flute.

The adhesive used to bond a liner to the apex contact portions of a fluted sheet, where the liner and the fluted sheet are formed from Kraft paper, is typically a water-based glue.

The adhesive may also be a non-water based glue provided it is liquid-like during application to the apex contact portion and can be absorbed by the porous sheet material in accordance with the present invention.

The term “controlled amount of adhesive” refers to a measure of adhesive which is applied to the apex contact portion such that it does not extend beyond the apex contact portion prior to or during bonding step b). A “controlled amount of adhesive” can therefore include a bead of glue, coating of glue, or droplets of glue, which is/are placed along, or on, the apex contact portion of each crest of a fluted sheet.

The controlled amounts of adhesive can vary in form depending on the mode of application.

In some embodiments, the distinct amounts may be in the form of a thin line, smear, a network of fine interconnected lines, interrupted line(s) or dash(es).

The key for achieving a bond between the respective sheets is for the adhesive to first wet and penetrate the corrugated sheet and then wet and penetrate the second sheet (liner).

By having a controlled amount, less adhesive is applied to the fluted sheet than is the case with conventional methods. Further, a controlled amount also ensures that the adhesive does not extend beyond the apex contact portion and especially so during step b). Thus a controlled amount allows for some spread of adhesive to occur on to dry areas of the respective sheets once pressure has been applied to the liner and the fluted sheet.

In one preferred embodiment the adhesive is applied across the apex contact portion in spaced apart droplets in a manner substantially as is disclosed in the applicant's earlier PCT Application WO 2009/145642 where the droplets are applied to the crest.

It is envisaged that the droplets will be small round, or pear shaped portions of adhesive that adhere to a surface, but this should not be seen as limiting.

The preferred size of the droplet may depend on a number of factors, including the nature of the fluted paper and liner and the type of adhesive used. However, in all cases the droplet size should be small enough that the droplet substantially retains its form and does not collapse under its own weight. This is important as the relatively high volume to surface area (in comparison say to a strip or line of adhesive) reduces the rate of evaporation of moisture from the droplet, thus extending the time available for the droplet of adhesive to wet and penetrate the crest of the fluted paper and the liner prior to the adhesive drying out.

A preferred droplet size is in the order of 0.5 mm³. The preferred gap between droplets is calculated by ascertaining the desired adhesive thickness when spread and placing the droplets apart so when the spread droplets reach that thickness they just meet each other.

In another preferred embodiment the adhesive is applied to the apex contact portion in the form of a thin continuous bead (i.e. line of adhesive).

The applicant has found that the present method can be used to produce single face corrugated board without the application of heat to effect a bond between the fluted sheet material and the liner sheet material.

As used herein the term “ambient temperature” refers to the temperature of the room/building in which the apparatus can operate and perform the method of the present invention. In general the ambient temperature is a temperature between substantially 5° C.-60° C. Most preferably an ambient temperature may be a temperature of between substantially 10° C.-25° C.

It should be appreciated that the choice of adhesive of the present invention is important. As noted in the Background Art, starch based adhesives require a activation temperature in the order of 150° C. Thus, such an adhesive would not be desirable for use with the present invention unless activated prior to application (for example by heating in a storage vat). Suitable adhesives that can set rapidly at room temperature, and have the required bond strength, are discussed later on in this specification.

It is a significant advantage of the present invention that it can produce corrugated board without the application of heat to the porous materials to be bonded. As discussed further in the specification, this removes the need for expensive machinery and significantly reduces energy requirements. It should be appreciated that it is the recognition that the application of a controlled amount of adhesive to the apex contact portion of porous corrugated sheet at a sufficient pressure enables the significant advantage to be achieved through shorter bonding time at ambient temperatures.

In the second step of the method according to the present invention the liner is pressed against the fluted sheet at a specified pressure for a specified time so a bond can form. This may be achieved by a variety of means.

In a preferred embodiment the planar (liner) sheet is pressed against the corrugated (fluted) sheet by a tensioned endless belt assembly

The exertion of pressure on a liner to press it against a fluted sheet by use of a tensioned endless belt, is well known in the art and the equipment to do so need not be discussed in further detail.

The term ‘specified pressure’ as used herein refers to the pressure applied by the belt to the large surface of the corrugating roller which is set to be at, or just below, the maximum pressure that can be applied without deforming the paper (liner and fluted papers). Excessive pressure can lead to creasing and/or tearing of the paper. The maximum pressure will vary depending on the material used for the liner and fluted paper.

In a preferred embodiment the sheet materials are held together for a period not less than two seconds.

The applicant has found that when using an endless belt (tensioned to hold the liner firmly against the crests without damaging the liner), in combination with a suitable commercially available adhesive, the liner and fluted sheet need to be pressed together for a period (pressing time) longer than about two seconds at room temperature to ensure the liner and fluted board form a good bond.

Typically, if the pressing time is less than around two seconds, or if the pressure between the sheets is too little, a single face corrugated board will not be completely or adequately formed. In such cases, the tension in the corrugated sheet is sufficient to break the bond, resulting in the liner coming away from the fluted sheet.

For practical purposes at room temperature holding times between two seconds and four seconds are desirable, with a pressing time of around three seconds being preferred. Pressing times greater than four seconds may be used, but are not preferred as such times may significantly reduce the production rate of single face corrugated board unless the size of the corrugating roller is increased.

However, the inventor's discovery of a formula governing the specified processing time enables a person skilled in the art to manipulate the configuration of the apparatus to achieve faster rates of production within the confines of physical properties of the paper and adhesive being used.

A pressing time of around two or three seconds is significantly slower than that achieved by some prior art machines which use a combination of high temperature and high pressure. However, an advantage of the present invention is that it may produce quantities of single face corrugated board at an acceptable rate at room temperature. This provides the advantage of a process and apparatus which may produce single face corrugated board at a reduced cost and in a safe and environmental friendly manner.

The inventor considers the combination of:
using a controlled amount of adhesive;
applying the adhesive to the apex contact of the corrugated sheet;
holding the corrugated and planar sheets together a specified pressing time in order to form a bond; and
using an adhesive that can set at ambient temperature;
   enables the commercial manufacture of single face corrugated board via a cold process.

In a preferred embodiment the adhesive is a water-based glue suitable for bonding porous materials such as paper. In preferred embodiments the adhesive may be a dispersion containing vinyl acetate copolymer.

A water-based adhesive containing vinyl acetate copolymer in dispersion may be preferred as, under normal use, it is a non-hazardous substance, and therefore can be used safely provided normal ventilation is provided.

Vinyl acetate copolymer dispersions can be relatively quick setting at room temperature and do not require a high activation temperature—unlike starch based glues. They have a low viscosity, good adhesion and a long open time. A relatively low viscosity is required to allow the adhesive to flow readily, (e.g., when being transferred from an applicator to the fluted sheet) while a good adhesion provides the ability to adhere quickly to a surface.

The open time is a measure of the time, under normal temperature and pressure, that the adhesive can have an exposed surface before it loses its ability to wet the opposing surface and penetrate into the opposing surface fibres. This wetting and penetration is required to form an effective bond between the fluted paper and the liner. An adhesive having a relatively long open time is preferred as the adhesive may be open to the atmosphere for some time prior to application to the flutes.

Preferably the adhesive is Adhesin™ Z9129W, a vinyl acetate copolymer supplied by Henkel New Zealand Limited. The applicant has found that Adhesin™ Z9129W has the required viscosity, and long open time required for use with the present invention. For example, Adhesin™ Z9129W has a viscosity in the range 2100-2200 m·Pa·S and an open time of between 0.5 to 1 minute. However, it is envisaged that other adhesives having similar properties may also be used.

Applying an adhesive (such as Adhesin(Z9129W) in droplet form to the crest of a fluted sheet, and pressing a liner against the crest for around 3 seconds to form a bond between the fluted sheet and liner, provides a number of significant advantages over the prior art. In particular, the method may be used to produce single face corrugated paper board at ambient temperature. As a result there is no need for heating of the corrugating rolls or drying out of the single face corrugated board. This may translate into a significant reduction in energy use and hence lower the production cost of the paper board.

In some preferred embodiments, a glue applicator for applying a controlled amount of adhesive, includes a roller wherein the outer surface of the roller has a contoured surface.

Another adhesive found to be suitable is Adhesin™ Z9040 which takes around 2 seconds to form bond between the fluted sheet and the liner.

The contoured surface can come in a number of forms and in one embodiment may be a dimpled or an irregular surface. In some embodiments the contoured surface may be in the form of a U-shaped groove. The roller may also in some further embodiments be similar to an anilox roller.

Preferably however, the contoured surface is in the form of fine corrugations reminiscent of a square wave.

In one preferred embodiment the contoured surface may be a corrugated surface. It should be understood that a corrugated surface refers to a surface formed into a series of crests and troughs.

In a preferred embodiment the crests (and troughs) are substantially parallel and extend around the circumference of the roller.

In a preferred embodiment the crests form a spiral.

In other embodiments the crests may form concentric circles.

Preferably the crests and troughs may be formed by cutting (or otherwise shaping) a ‘V’ or square shaped groove in the surface of the glue roller. The actual shape of the groove is not critical, but a ‘V’ shaped groove is preferred as it is relatively easily cut into a smooth cylindrical surface.

In use, adhesive may be supplied to the glue roller by a smooth surface pick-up roller.

Alternatively, spray nozzles may be used or an air blade that passes through a trough.

In an embodiment that has a pick up roller, the pick-up roller is preferably mounted adjacent to an adhesive bath such that the outer surface is coated with adhesive as the pick-up roller rotates.

The glue roller is mounted with respect to the pick-up roller such that the crests of the glue roller make firm contact with the surface of the pick-up roller. In this way adhesive is transferred from the surface of the pick-up roller into the grooves in the surface of the glue roller, with little or no adhesive being applied to the crests of the applicator roller.

The gap between the pick up roller and the glue roller determines the amount of glue being applied.

Preferably the mounting of the glue roller is also such that the crests of the applicator roller make firm contact with the crests of the fluted sheet on the corrugating roller. With this arrangement as the glue roller rotates it picks up adhesive in the grooves on its surface as it contacts the pick-up roller, and then deposits the adhesive as droplets onto the crests of the fluted sheet.

The amount of adhesive for each droplet may be determined by the size (width and depth) of each groove, while the separation of the droplets may be determined by the separation of adjacent grooves.

It should be appreciated that the groove should be sufficiently shallow to avoid too much glue being deposited onto the corrugated sheet material. In other words the groove should be dimensioned so that glue is only deposited onto the apex contact portion. In a preferred embodiment, the depth of the groove is 0.5 mm and the width of the groove is in the order of 1 mm.

In a preferred embodiment the crest may take the form of a sharp edge.

Preferably, the V′-shaped grooves on the roller are arranged such that each groove abuts the adjacent grooves to form a sharp edge so that a section through a series of grooves forms a continuous zigzag pattern. This arrangement may provide the minimum separation between adjacent droplets (for a given width of each groove).

In some other embodiments the crests may have a flat section, in which case the separation of the droplets may be correspondingly larger.

The glue roller is rotatably mounted such that the outer surface (crests) of the applicator press against the crests of the fluted paper held on the second corrugating roller.

According to another aspect of the present invention there is provided a method of bonding a substantially planar sheet material to a corrugated sheet material both of which are porous using a continuous process the method characterised by the steps of:
a) applying adhesive to the corrugated sheet material with a glue application (GA) roller which has lateral left to right grooves about the GA roller's circumference which engage with teeth on the corrugating roller wherein said grooves in the GA roller hold a set amount of glue therein
b) holding the respective planar and corrugated sheets together at a specified pressure and for a specified time so a bond is formed there between.

The dimensions of the grooves on the GA roller enable
a line of adhesive to be held therein;
the teeth (or a portion thereof) on the corrugating roller and apex contact portion of the corrugated sheet to be received therein;
   such that a line of adhesive can be applied to the apex contact portion of the corrugated sheet.

According to another aspect of the present invention there is provided an apparatus for making single face corrugated board by bonding a corrugated sheet material having one or more crests onto a substantially planar sheet, both of which are porous, the apparatus including

an applicator configured to apply adhesive to each crest of the corrugated sheet material, and
a pressing mechanism for pressing the planar sheet against the crest of the corrugated material
characterised in that
the applicator is configured to apply a controlled amount of adhesive to apex contact portions on each crest of the corrugated sheet material and wherein the pressing mechanism is configured to press the planar sheet material against the corrugated sheet material at a specified pressure for a specified time so a bond is formed there between.

Accordingly an apparatus for making single face corrugated board according to the present invention has many features in common with some prior art machines. In particular a fluted sheet is formed by passing a sheet material between the intermeshed teeth of first and second corrugating rollers. The fluted sheet is held against the second corrugating roller, which has a larger diameter than the first corrugating roller, by a vacuum created inside the second corrugating roller.

As the second corrugating roller rotates, the fluted paper passes an applicator where adhesive is applied to the apex contact portion of the fluted sheet. In a preferred embodiment the applicator includes a roller having a corrugated surface substantially as described above.

The corrugated surface of the glue roller and grooved surface of the GA roller (as described above) are respectively configured to apply droplets or a line of adhesive across an apex contact portion on a crest of a fluted sheet. This is in contrast to conventional machines in which the applicator typically has a knurled surface so as to spread a relatively broad strip or line of adhesive across the crest of the flute. Conventional machines therefore tend to apply more adhesive than is required and the adhesive is thus not contained within the apex contact region.

In a preferred embodiment the pressing mechanism is a tensioned endless belt assembly.

An endless belt may be configured to move around a plurality of rollers, the rollers being arranged such that the belt is held in contact with the liner as the liner and fluted sheet move around the periphery of the second corrugating roller.

This arrangement may be achieved by placing two end guide rollers spaced apart around the periphery of the second corrugating roller, the spacing defining the distance over which the belt contacts the liner. The two end guides may be mounted so as to provide pressure (via the belt) onto the liner as it initially contacts the fluted sheet, and again just before the single face fluted sheet is removed from the second corrugating roll.

The belt may be tensioned by adjustment of one or more of the remaining rollers so that the belt applies pressure to the liner to press it against the fluted sheet.

As there is no heating required, a standard rubber belt may be used, rather than the more expensive materials used with heated rollers. Use of a standard rubber belt may result in less damage to the surface of the liner, and hence a superior product.

In other embodiments the endless belt may be made of plastics or synthetic material.

An advantage of the present method, when applied at ambient temperature, is that the endless belt may be formed using heat sensitive materials such as plastics, synthetics and some rubbers that would not be suitable in conventional, heated processes.

In a preferred embodiment the endless belt is configured to press the sheet materials together for at least 2 seconds.

In a preferred embodiment the endless belt is configured to press the sheet materials together for a time between about 2 seconds and about 4 seconds as aforesaid.

In other words, the present invention allows the efficient production of single face corrugated board without requiring additional heat to be applied to the process.

This feature is achieved by the combination of applying a controlled amount of adhesive to the apex contact portion followed by pressing the liner against the fluted sheet at a specified pressure for a specified pressing time until a bond is formed.

According to a further aspect there is provided an apparatus which bonds substantially planar porous sheet material to a corrugated sheet material via a continuous process wherein the apparatus includes large corrugating roller which intermeshes with a smaller corrugating roller wherein the diameter of the smaller roller is at least substantially between 0.16 m-0.2 m diameter and the large corrugating roller has a diameter of at least substantially between 0.4 m-2.0 m.

The ability to form single face corrugated board at ambient temperatures provides one or more of the following advantages over the prior art.
Saving in energy cost and a lower carbon footprint than conventional methods through removing the need to heat the corrugating rolls and to dry the paper. This removes the requirement for high pressure steam which is very energy intensive.
Saving in the cost of machinery. As heating is not required, there is a significant saving in not requiring boilers, pipe work and containment for high pressure steam. Further, as the machine is operated at room temperatures it can be constructed from simpler and less expensive materials, such as (without limitation) ceramics, plastics or wood. As such materials are generally easier to form and lighter than the materials (generally hardened steel) used in conventional machines that use steam, the machine may be cheaper to make and be supported by a lighter frame, again saving on material cost.
Saving in space. Removal of the apparatus associated with heating may result in an apparatus that requires less space than conventional, heated machines.
Improved safety. As the machine operates at room temperature, the hazards associated with production and use of high pressure steam are no longer present.
Saving in operating costs. Apart from a reduction in energy usage, the present method may result in significantly less consumption of adhesive.

Importantly an apparatus according to the present invention may be of a size and cost that makes it suitable for on-site production of single face corrugated board. Conventional heated machines are typically large, energy intensive and expensive to construct and operate. As a consequence such machines are commonly operated in centralised locations, with the single face corrugated board, or products made from it, transported to consumers.

The size of the machine according to the present invention is scalable, mainly because no heating apparatus is required. Hence, an apparatus according to the present invention may be of a size suitable for installation and operation on the site of the consumer, for example to make packaging on site. This may provide savings to the consumer, as supply would be controlled by the consumer, and there would be no transport and handling costs from off-site production.

According to another aspect of the present invention there is provided the use of the principle:

RP=DHT/BT

in the construction of a single face paperboard manufacturing facility;
wherein RP is the rate of production in metres/minute; DHT is the distance in metres for which the two respective sheets are held together; and BT is the bond time of the adhesive in minutes.

According to a further aspect of the present invention there is provided a use of a water based adhesive in the production of single face paperboard.

According to a still further aspect of the present invention there is provided the use of adhesive may be a dispersion containing vinyl acetate copolymer.

According to yet another aspect of the present invention there is provided an apparatus for manufacturing corrugated sheet of material from porous planar sheet material via an automated process wherein the apparatus includes:
a corrugating roller;
an endless fluted conveyor belt assembly having an endless fluted conveyor surface including a plurality of adjacent flutes wherein the flutes are configured to correspond to the teeth on the corrugating roller.

According to a further aspect of the present invention there is provided an apparatus for manufacturing a single face corrugated sheet of porous material via an automated process wherein the apparatus includes:
a corrugating roller;
an endless fluted conveyor belt assembly having an endless fluted conveyor surface including a plurality of adjacent flutes wherein the flutes are configured to correspond to the teeth on the corrugating roller;
a pressure mechanism configured to hold freshly corrugated sheet material to the fluted conveyor surface whilst adhesive is applied by a glue applicator;
an endless tensioned belt assembly which holds planar sheet material and the corrugated sheet material together so a bond is formed there between.

It should be appreciated by a person skilled in the art, that apart from the substitution of an endless fluted conveyor belt assembly, in place of the large corrugating roller, most if not all of the features and aspects described earlier in relation to the present invention also equally apply to this linear endless slatted conveyor. The exception of course being in relation to aspects peculiar to the large corrugating roller. For example the rate of production, specified pressing time, adhesives, suitable porous sheet materials all apply to the linear assembly.

The endless fluted conveyor surface may come in a variety of different forms without departing from the scope of the present invention.

In one preferred embodiment the endless fluted conveyor surface may be formed from a plurality of pivotally linked strips of rigid material which have a fluted (corrugated) edge or surface.

In some preferred embodiments the strip may be in the form of a slat.

In some further preferred embodiments the strip may be in the form of a bar which has a rectangular transverse cross section.

The bars or slats may each have connection portions at opposed ends thereof (with respect to the intended direction of travel along the conveyor) to enable pivotal attachment to adjacent strips to form and endless fluted conveyor surface.

In another preferred embodiment the endless fluted conveyor surface may be in the form of an endless belt. In some such embodiments the belt may include a flexible base layer and a fluted rigid outer layer, wherein the outer layer is configured to move around rollers forming part of the conveyor belt assembly.

The endless fluted conveyor surface may be made from a variety of different materials without departing from the scope of the present invention.

In one preferred embodiment the bars/slats are made from steel.

In other embodiments the bars/slats may be made from plastics, wood, or composite materials.

In another preferred embodiment the bars/slats may be made of Perspex.

The teeth on the corrugator and flutes on the endless conveyor may have a number of different profiles without departing from the scope of the present invention provided the shape of the flutes are capable of intermeshing with the teeth on a corrugating roller. For example the teeth on the roller may have any one of: A, B, C, D, E, F or G shaped profiles.

In one preferred embodiment the teeth/flutes may be formed via V-Shaped grooves.

In some preferred embodiments the endless conveyor surface may include a number of apertures passing from the top to the bottom surface and positioned substantially along the length of the endless conveyor surface. The purpose of the apertures is to allow for the application of a vacuum to the corrugated sheet material to hold it against the flutes of the endless conveyor surface.

In one preferred embodiment the apertures may be in the form of slots which form a staggered pattern along the length of the endless conveyor surface.

The pressure mechanism may come in a variety of forms without departing from the scope of the present invention.

In embodiments where the slats do not include apertures as aforementioned the pressure mechanism may be in the form of two or more elongate fingers which pass through radial grooves in the corrugating roller and glue roller. Alternately the corrugating roller and glue roller may be constructed in sections with a gap between sections in which the fingers may be located. The fingers are attached to a biasing device which allows the fingers to hold the corrugated sheet material against the slatted conveyor.

In preferred embodiments the pressure mechanism may be in the form of a vacuum box located within the slatted conveyor and configured to apply a vacuum to the slats as they pass the vacuum box.

The endless belt assembly may be configured to move around a plurality of rollers as is well known in the art. The rollers being arranged such that the belt is held in contact with the liner as the liner and fluted sheet move around the periphery of the endless fluted conveyor belt assembly which effectively functions as a second corrugating roller.

The endless fluted conveyor belt assembly which is formed from a plurality of adjacent slats may be configured in a number of different ways without departing from the scope of the present invention.

In a preferred embodiment the slatted conveyor belt assembly may include one or more flexible belts to which the slats are attached. The belts move around rollers and are driven by a drive mechanism as is known in the art.

The glue applicator may take a number of different forms.

Preferably, the glue applicator may be a grooved glue roller which intermeshes (engages) with the teeth on the slats. The glue roller receiving glue from a glue pick up roller and associated glue tray.

However, the glue applicator may also be configured in other ways substantially as described above.

According to another aspect of the present invention there is provided an apparatus for manufacturing double face corrugated board via a continuous in-line automated process wherein the apparatus includes:

i) a single face corrugator module comprising:
a corrugating roller;
an endless fluted conveyor belt assembly having an endless fluted conveyor surface including a plurality of adjacent flutes wherein the flutes are configured to correspond to the teeth on the corrugating roller;
   wherein the module is configured so that sheet material passing between the respective intermeshing teeth on the corrugating roller and endless fluted conveyor belt assembly becomes corrugated and is subjected to a first pressure mechanism before contacting a glue applicator and coming into contact with planar sheet material and a second pressure mechanism in the form of an endless tensioned belt assembly which holds the respective planar and corrugated sheets together so a bond is formed there between;
   ii) a laminator module comprising:
two vertically opposed endless linear tensioned belt assemblies which receive there between:
a) planar sheet material; and
b) single face corrugated sheet material from the corrugator module
   wherein a glue applicator applies adhesive to the single face corrugated board and/or planar sheet material prior to entering the opposed endless tensioned belt assemblies which hold the planar sheet material and single face corrugated board together so a bond is formed there between.

According to yet another aspect of the present invention there is provided a method of bonding for use in the manufacture of single face or double face corrugated board (both of which are porous) characterised by the step of using an arrangement of at least one endless linear tensioned belt assembly and one endless fluted conveyor assembly to hold corrugated sheet material together with planar sheet material so a bond is formed there between.

According to another aspect of the present invention there is provided a method substantially as described above where the corrugated sheet material and planar sheet material are held together for a specified pressing time calculated by the formula:

BT=DHT/RP

wherein RP is the rate of production in metres/minute; DHT is the distance in metres the two respective sheets are held together; and BT is the bond time in minutes of the adhesive used and this determines the pressing period.

According to another aspect of the present invention there is provided single face board which has been produced by a method substantially as described above.

According to yet another aspect of the present invention there is provided double face board which has been produced by a method substantially as described above.

According to an additional aspect of the present invention there is provided double face board which has been produced from single face board substantially as described above.

According to a further aspect of the present invention there is provided single face board which has been produced from a pre-printed planar sheet being directly bonded to a corrugated sheet material at an ambient temperature.

According to a further aspect of the present invention there is provided pre-printed double face board which has been produced from a pre-printed planar sheet being directly bonded to a corrugated sheet of material forming part of a single face board which was produced at an ambient temperature.

Preferably, the pre-printed planar sheet is applied to the single face board immediately after it has been formed as part of the automated continuous in-line process.

According to a further aspect of the present invention there is provided double face board which has been produced from two pre-printed planar sheets being directly bonded to upper and lower surfaces of a corrugated sheet material at an ambient temperature.

It will be understood that the pre-printed planar sheets are bonded to the corrugated sheet material so that the printed surface(s) become exposed surface(s) of the single face/double face board.

The advantages achieved by the preferred embodiments of the endless linear tensioned belt assembly and endless slatted conveyor belt assembly can include:
providing a way of increasing the rate of production according to the formula: RP=DHT/BT wherein RP is the rate of production in metres/minute; DHT is the distance in metres the two respective sheets are held together; and BT is the bond time in minutes.
In particular the rate of production is not limited by X as for non-linear corrugators (i.e. intermeshing large and small corrugating rollers) which are governed by the formula C=(RP·BT)/X wherein C is the circumference of the larger roller (i.e. π2r); RP is the rate of production in metres/minute and BT is the bond time in minutes; and X is the percentage of the circumference about which pressure is applied by the endless tensioned belt. This formula arises from the fact DHT equates to X(π2r). The maximum value of X for large corrugator roller constitutes a rate limiting step—as the diameter of the large corrugator roller cannot be increased much beyond 2 meters as this would make the roller incredibly heavy. By way of contrast the length of a linear corrugator can be increased easily and almost without limit should this be desired.
Providing the aforementioned advantages for a cold process over conventional technology for producing not only single face but also double face corrugated board.

The advantages provided by preferred embodiments of the present invention in relation to both linear and non-linear corrugators also include:
the ability to apply pre-printed paper directly to the corrugated board as part of an in-line continuous automated process;
   the ability to produce single or double face corrugated board which is dead flat to the naked eye and not prone to curling due to the fact it has been produced with the absence of heat and with a passive braking system for paper coming off the reel.

### BRIEF DESCRIPTION OF DRAWINGS

Further aspects of the present invention will become apparent from the following description which is given by way of example only and with reference to the accompanying drawings in which:

FIGS. 1A and 1B show the apex contact portion on a schematic side elevation of a fluted sheet both pre- and post-bonding to the liner;

FIG. 2 shows a schematic perspective view of part of a single facer apparatus according to one preferred embodiment of the present invention;

FIG. 3 shows a perspective view of the single facer apparatus shown in FIG. 2;

FIG. 4 Shows a schematic perspective view of part of a single facer apparatus according to a further preferred embodiment of the present invention;

FIG. 5 shows a schematic perspective view of a linear corrugators for producing single face corrugated board in accordance with a preferred embodiment of a further aspect of the present invention; and

FIG. 6 shows a schematic perspective view of an apparatus for manufacturing double face corrugated board in accordance with a preferred embodiment of a further aspect of the present invention which utilises a linear corrugator substantially as shown in FIG. 6.

FIG. 7 shows a plan view of a cylindrical bar detailed in the embodiment shown in FIG. 2.

FIG. 8 shows a plan view of an alignment bar detailed in the embodiment shown in FIG. 2.

FIG. 9 shows a plan view of a convex roller detailed in the endless tensioned belt assembly of the embodiment shown in FIG. 2.

FIG. 10 shows a schematic perspective view of an apparatus for manufacturing double face corrugated board in accordance with a preferred embodiment of a further aspect of the present invention which utilises a modified linear corrugator to that shown in FIG. 6

FIG. 11 shows a portion of an endless conveyor surface in the form of a conveyor belt made from a plurality of strips in the form of fluted bars.

FIG. 12 shows side view of a fluted bar forming part of the conveyor belt of FIG. 11.

FIG. 13 shows transverse cross sectional view of the flute bar in FIG. 12.

FIG. 14 shows a perspective view of the fluted bar in FIG. 12.

### BEST MODES FOR CARRYING OUT THE INVENTION

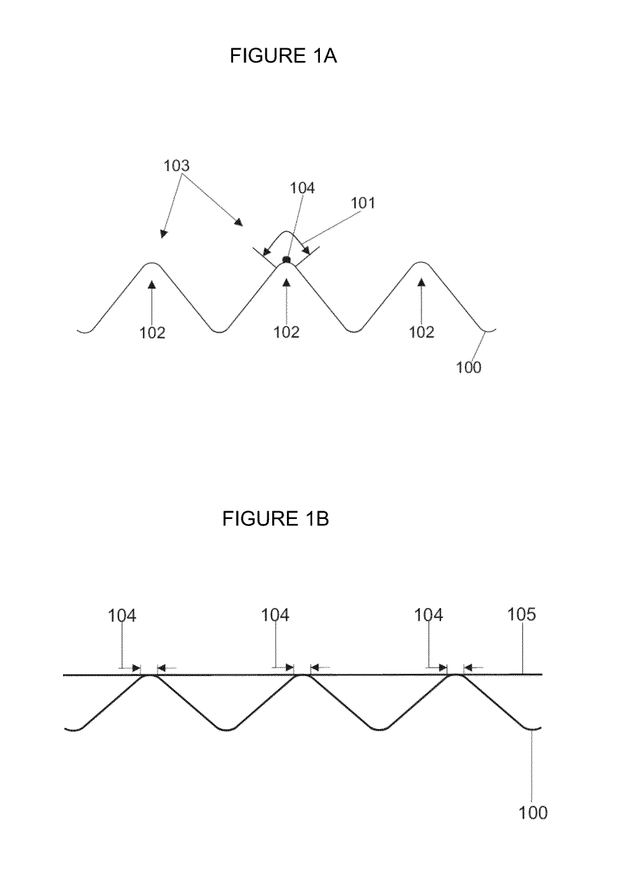

In FIGS. 1A and 1B there is shown a schematic view of a corrugated (fluted) sheet of paper (100) illustrating the apex contact portion (101).

The apex contact portion includes the apex (102) of the crests (103) and a region either side which will become abutted by the spread of adhesive (104) to the liner sheet (105).

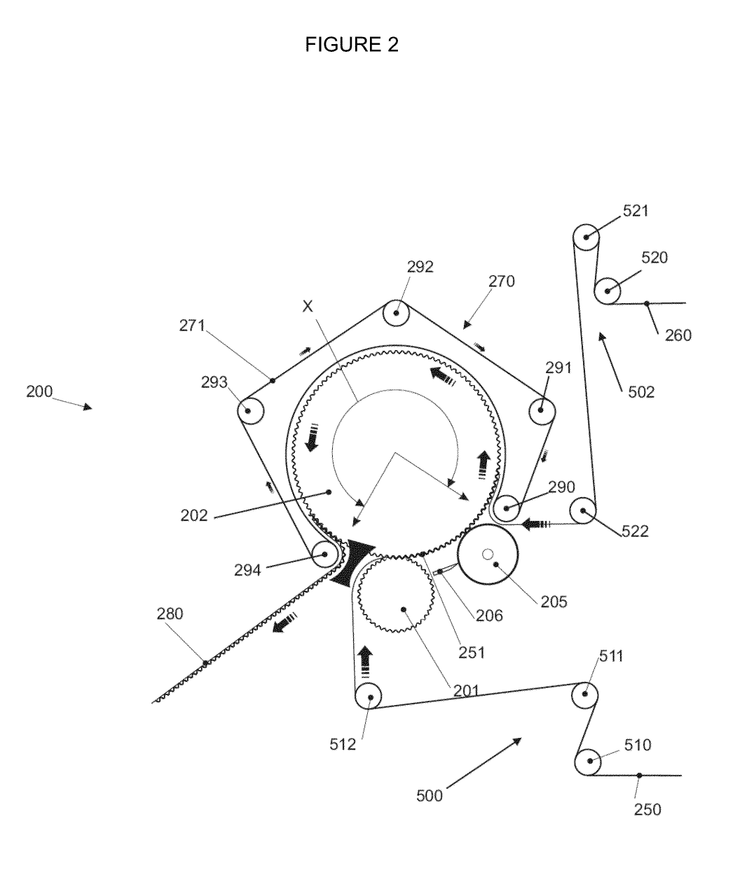

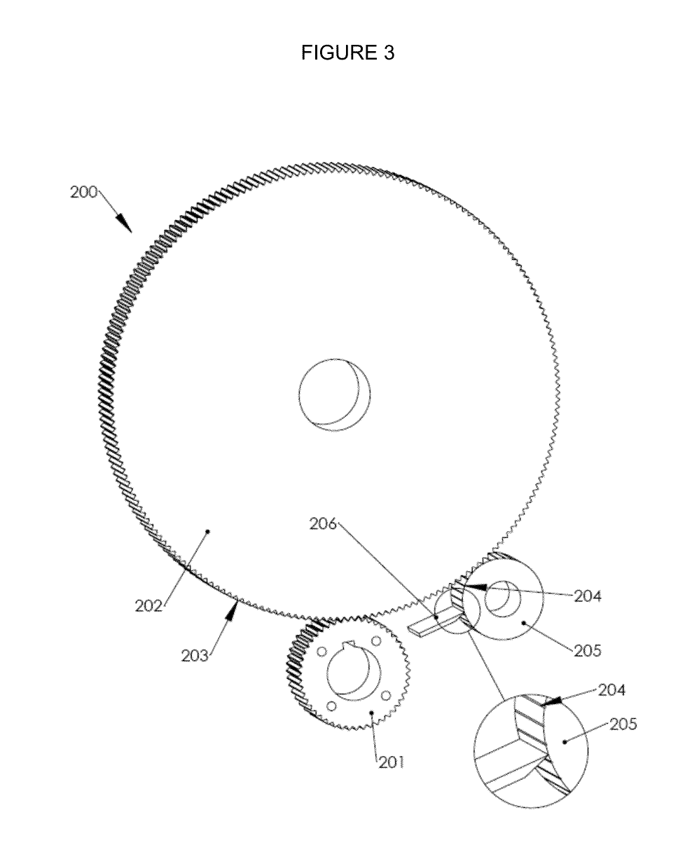

FIGS. 2 and 3 show a portion of an apparatus for forming single face corrugated board known as a single facer generally indicated by arrow (200). The single facer (200) has a first smaller corrugating roller (201) and a second large corrugating roller (202). It will be appreciated for clarity the rollers(201,202) pictured in this drawing are not shown in full but would be built up by a assembling a series of the roller components and placing these side by side on an axle (not shown) until the desired width of roller is achieved.

In operation porous sheet material in the form of Kraft paper (250) is fed to the corrugating rollers (201) and (202). After passing the rollers (201,202) the Kraft paper (250) becomes corrugated (fluted) sheet material (251).

The second roller (202) has teeth (203) which engage with lateral grooves (204) on the surface of a glue applicator (GA) roller (205). The surface of the glue applicator roller (205) picks up adhesive in the form of Adhesin™ Z9040 from a glue bath (not shown) and excess glue is removed from the surface via a glue scraper (206) such that adhesive only remains in grooves (204). In use newly corrugated sheet material (251) which is held via a vacuum to second roller (202) passes between the second roller (202) and glue roller (205) such that the apex contact portion (not shown) of the corrugated sheet material is received within the grooves (204) along with teeth (203) to achieve the transfer of adhesive to the apex contact portion.

At this point planar (liner) sheet material (260) in the form of Kraft paper is fed in between an endless tensioned belt assembly (270) and the second corrugating roller (202) and bought into contact with the apex contact portions of the corrugated sheet material (251). The endless tensioned belt assembly has an endless belt (271) which applies a specified pressure to the planar sheet (260) to hold against the corrugated sheet (251). The endless belt (271) applies a specified pressure to 76% of the circumference of large roller (20) as indicated by arrow X. It will be appreciated by those skilled in the art that the sheet material (260) can in some embodiments be pre-printed with high quality graphic images and/or text.

The endless tensioned belt assembly has a series of rollers (290-294) tension applied by radially adjusting a tension roller (292) with respect to the axis of the second large corrugating roller (202). In operation the tension in the belt (271) is first adjusted to the point where damage normally in the form of, creasing or tearing, of the liner and/or fluted paper occurs. The tension is then reduced by gradually adjusting the tensioning roller (292) back to a point where damage no longer occurs to the liner/fluted paper (i.e. the tensioning roller is adjusted back to the specified pressure).

The respective sheets (260,251) are held together for a specified time which is determined by the formula:

BT=DHT/RP

wherein RP is the rate of production in metres/minute; DHT is the distance in metres the two respective sheets are held together; and BT is the bond time in minutes. Thus, as can be seen the percentage of 360° as indicated by double headed arrow X that the endless tensioned belt contacts the circumference of the roller (20) is critical to determining the distance held together and hence the rate of production

The circumference of the second corrugating roller (202) is governed by the formula:

C=(RP·BT)/X

wherein C is the circumference of the roller (i.e. π2r); RP is the rate of production in metres/minute; and BT is the bond time in minutes and X is the percentage of the circumference about which pressure is applied by the endless tensioned belt.

Thus, if a rate of production of 44 m/min is required and the bond time of the adhesive is 2 s (i.e. 0.0333 min) the circumference of the second roller is 44×0.0333 which is 1.4666 divided by 76% which equals 1.93 m. This equates to a diameter of 0.62 m. In other words the DHT in this example is equal to 2πr multiplied by 0.76%.

The Kraft paper used may be recycled or virgin paper and ideally in the order of 90 to 150 gsm.

The second corrugating roller (202) has a network of conduits (not shown) which lead from a vacuum pump not shown to the surface of the roller (not shown) so that a partial vacuum can be created inside the corrugating roller (202) via the vacuum pump. This partial vacuum inside the second corrugating roller (202) holds the fluted sheet (260) in place against the teeth (203) of the second corrugating roller (203).

Also as shown in FIG. 2 the apparatus (200) has a first and second alignment system generally indicated by arrows (500) and (502).

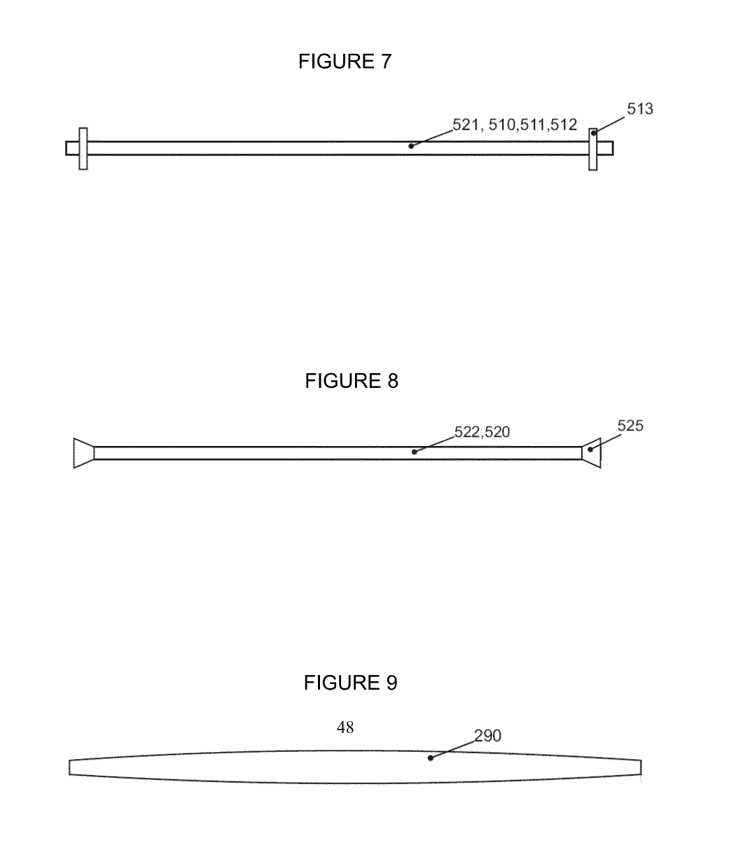

The first alignment system (500) has three cylindrical bars (510-512) which define a zigzag path for the paper (250) coming off the reel (not shown). The alignment system keeps the path of the paper (250) straight as it comes off the reel and enters the apparatus (200). The cylindrical bars (510-512) do not rotate but instead impart a frictional force which allows the bars to keep the path of the paper straight and prevent any left and right movement of the paper as it comes off the reel. To further assist with alignment of the paper the cylindrical bars (510-512) also have flanged ends (513) (refer FIG. 7) which prevent the paper from tracking off the cylindrical bars and becoming non-aligned with the apparatus (200).

The second alignment system (502) has a first alignment bar (520) which has flared ends (525) (refer FIG. 8) which taper out from a cylindrical centre section which is the width of the paper (260) coming off a reel (not shown). The flared ends extend about 50 mm out from the edge of the paper (260) passing over the bar (520). The paper (260) then passes around a cylindrical bar (521) which has flanged ends (refer FIG. 7). The paper (260) then passes to a second alignment bar (522) which has flared ends refer (FIG. 8). Again the bars ((520,521 and 522) are stationary as with the first alignment system (500).

Before entering the apparatus (200) the paper (260) passes over roller (290) of the endless tensioned belt assembly (270). The roller (290) has a convex outer surface (refer FIG. 9). The inventor has found that the convex outer surface on this roller minimises the risk of the paper gathering in the centre and creasing prior to entering the apparatus (200). This gathering occurring as a result of the paper being redirected towards the centre via the second alignment bar (522) whose flared ends prevent any left or right deviation of the paper over the bar (522).

It will be appreciated by those skilled in the art that the relative position of the bars with respect to each other and the respective reels in the first and second alignment systems (500) and (502) may be adjustable so the right pressure can be applied to the paper to keep it aligned with the apparatus (200).

In operation the endless tensioned belt assembly (270) via the belt (271) applies pressure to the liner (260) and the fluted paper (251) (formerly Kraft paper 250), as they respectively travel around 76% of the circumference of the roller (203) as indicated by arrow X: until single face corrugated board (280) is created and exits the apparatus (200).

It should be appreciated by those skilled in the art that embodiments with large and smaller intermeshing corrugating rollers such as shown in FIGS. 2, 3 and 4 can also be used to form double face corrugated board. In order to do so, the apparatus also includes a double facer (not shown) but which is well known in the art.

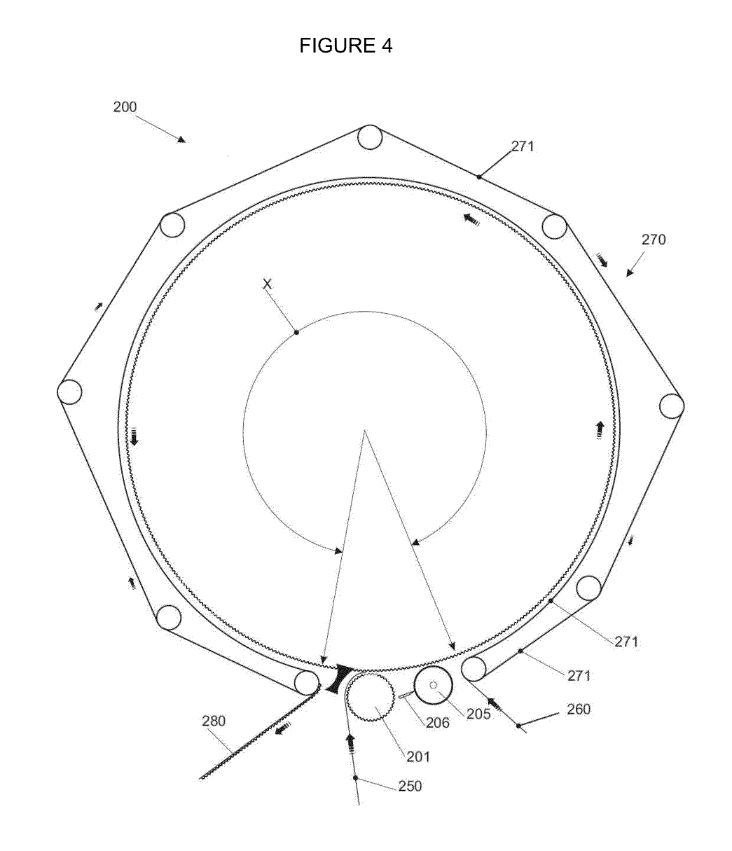

It will be appreciated although not shown alignment systems for paper coming off the reels are also employed in the embodiments depicted in FIGS. 4, 5 and 6. The alignment systems may be substantially the same as that shown and detailed for FIG. 2.

FIG. 4 shows an apparatus which is similar to that shown in FIGS. 2 and 3 and thus like reference numerals have been used to indicate similar elements. The key differences with the embodiment shown in FIG. 4 is the fact that the radius of the large corrugating roller (202) is 1 m whereas in FIGS. 2 and 3 the large corrugating roller (202) has a diameter of 2 m and the endless belt (271) applies a pressure about 93% of the circumference of the large roller (202) as indicated by arrow X.

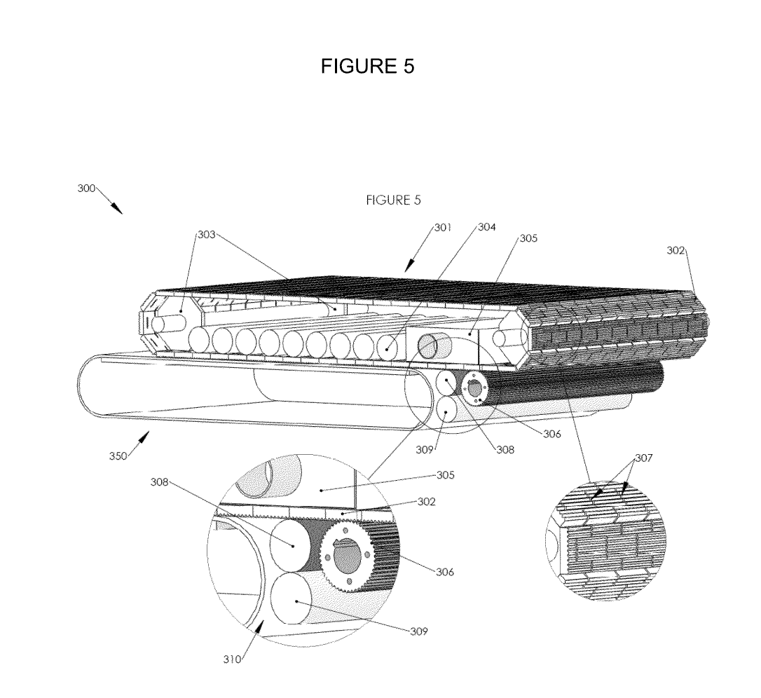

FIG. 5 shows an apparatus for manufacturing single face corrugated sheet material in the form of a linear corrugator generally indicated by arrow (300). The apparatus (300) includes an endless fluted conveyor surface in the form of an endless slatted conveyor belt assembly (301) which has a plurality of adjacent fluted slats (302) attached to a couple of flexible endless belts (not shown) which is driven by a drive mechanism which has a motor (not shown) and a pair of drive sprockets (303). The endless conveyor belt assembly has a number of dummy rollers (304) which keep the endless belt (not shown) and slats (302) on the bottom surface at a fixed height relative to an endless tensioned belt assembly (350). The drive mechanism and rollers of the endless tensioned belt assembly (350) are not shown given such arrangements are well known in the art.

The endless slatted conveyor belt assembly (301) has a vacuum pump (305) which can apply a vacuum to freshly corrugated sheet material in the form of Kraft paper (not shown) which has just passed in between corrugating roller (306) and endless slatted conveyor belt assembly (301). Apertures in the form of slots (307) in the slats (302) allow the vacuum to be imparted onto the corrugated Kraft paper.

After exiting the corrugating roller (306) the corrugated Kraft paper has a controlled amount of adhesive (not shown) applied to the apex contact portions (not shown) of the crests (not shown) via a glue roller (308) which has a grooved surface (not depicted). It should be appreciated that this glue roller (308) may also be the same as that described as being suitable for, as well as that actually depicted, in the embodiment shown in FIGS. 2, 3 and 4. Adhesive is taken from a glue tray (not shown) and transferred to the glue roller (308) via a glue pick-up roller (309).

The glue roller (308) may preferably be configured to be capable of being moved laterally with respect to the tensioned belt assembly (310) so as to be adjustable in order to accommodate smaller width paper. [A planar sheet of material in the form of Kraft paper liner (not shown) is introduced in between the slatted conveyor belt assembly (301) and the endless tensioned belt assembly (350) at the point indicated by arrow (310). The length (i.e. the extent) that the slatted conveyor belt assembly (301) and endless tensioned belt assembly (350) overlap represents the DHT.

As will be understood the length of the slatted conveyor belt assembly (301) and endless tensioned belt assembly (350) can both be extended to increase the rate of production according to the formula: RP=DHT/BT.

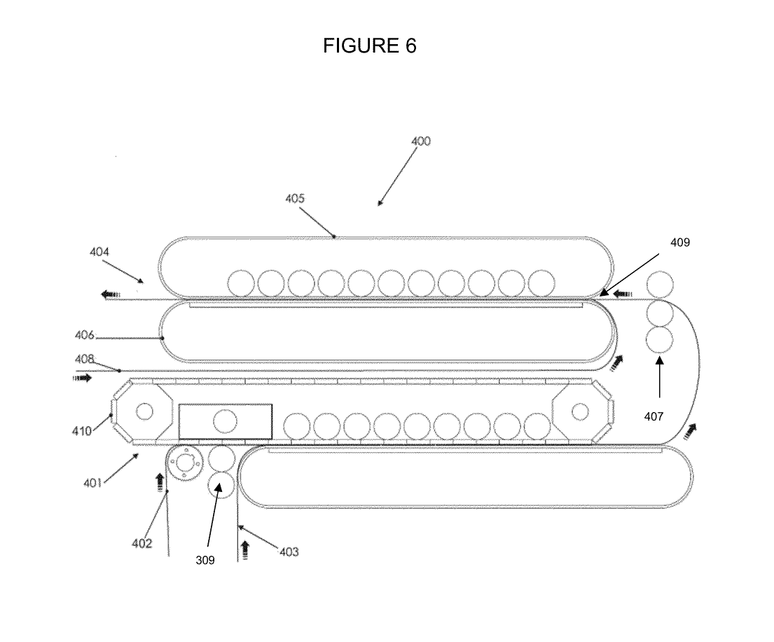

FIG. 6 shows a portion of an apparatus for manufacturing double face corrugated sheet material generally indicated by arrow (400). The apparatus (400) has a single face corrugating module in the form of a linear corrugator (401) substantially as described above in relation to FIG. 5. Thus, Kraft paper (402) to be corrugated enters the linear corrugator (401) as shown and Kraft paper (403) which will form the liner enters the linear corrugator after the glue rollers (407) as shown. Situated above the linear corrugator (401) is a laminator module in the form of a double facer (404). The double facer (404) has two endless opposed tensioned belt assemblies (405,406) and a glue applicator and nip roller assembly (407) through which the single face corrugated board passes before entering the double facer (404). The glue roller assembly (407) is substantially the same as that described in relation to FIG. 5. The Kraft paper (408) which forms the double face liner enters the apparatus (400) and travels along the top of the endless slatted conveyor (410) of the linear corrugator (401) before it enters the double facer (404) together with the single face corrugated board at the point indicated by arrow (409).

It will be appreciated by those skilled in the art that the planar sheet material used in the embodiments shown in FIGS. 5 and 6 can in some embodiments be pre-printed with high quality graphic images and/or text. For example in FIG. 6 the planar sheet material (403) and (408) can be pre-printed.

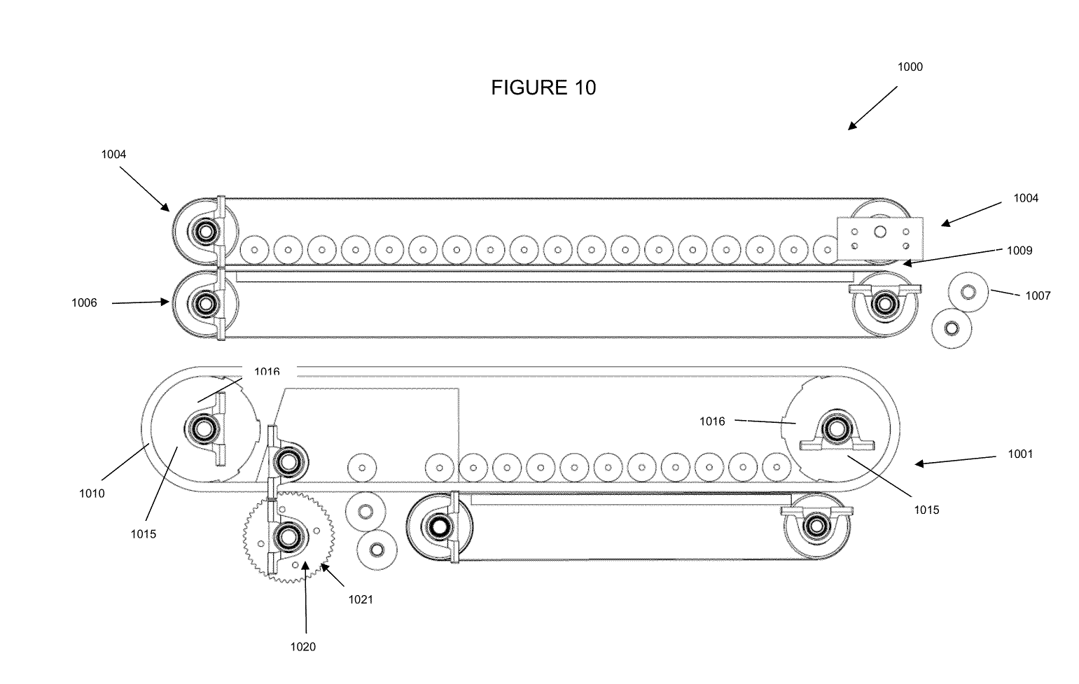

FIG. 10 shows a portion of an apparatus for manufacturing double face corrugated sheet material generally indicated by arrow (1000). The apparatus (1000) has a single face corrugating module in the form of a linear corrugator (1001) substantially as described above in relation to FIG. 5. Situated above the linear corrugator (1001) is a laminator module in the form of a double facer (1004). The double facer (1004) has two endless opposed tensioned belt assemblies (1005,1006) and a glue applicator and nip roller assembly (1007) through which the single face corrugated board (not shown) produced by the linear corrugators (1001) passes before entering the double facer (1004). The glue roller assembly (1007) is substantially the same as that described in relation to FIG. 5. The Kraft paper (not shown) which forms the double face liner enters the apparatus (1000) and travels along the top of the endless fluted conveyor surface (1010) of the linear corrugator (1001) before it enters the double facer (1004) together with the single face corrugated board at the point indicated by arrow (1009).

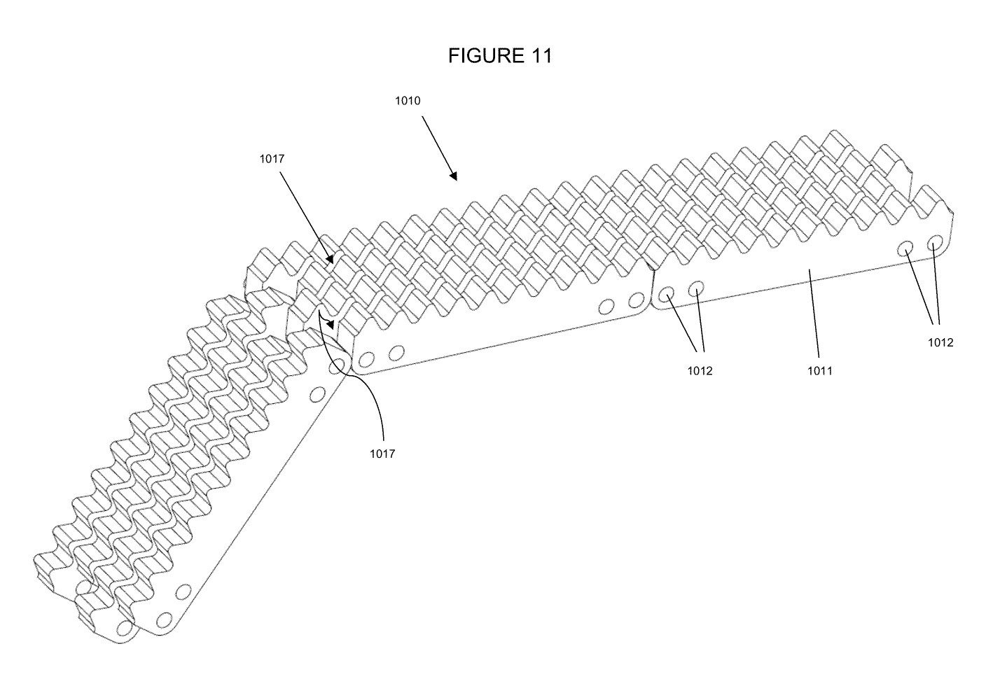

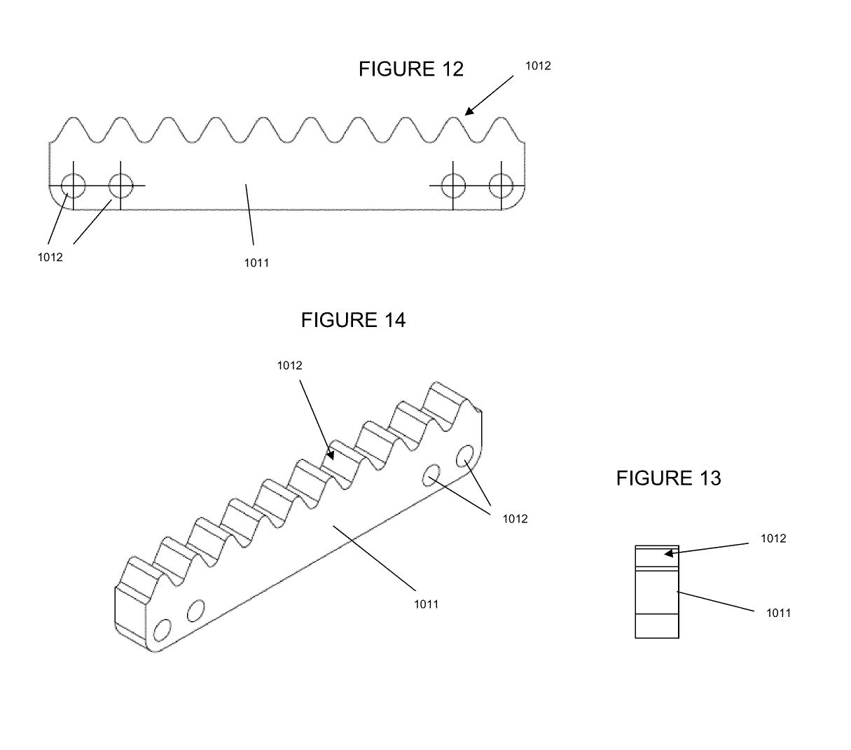

One notable difference with the apparatus shown in FIG. 10 over that shown and described in FIGS. 5 and 6 relates to the form of the conveyor assembly of the linear corrugator (1001). The endless conveyor surface (1010) is formed from fluted bars (1011)—as shown in FIG. 11 as opposed to fluted slats as shown in FIG. 5—which are again arranged to form an endless belt. The fluted bars (1011) have connection portions in the form of a pair of apertures (1012) at either end thereof which can receive pins (not shown) to join adjacent bars (1011) to one another to form the belt (1010) The fluted bars (1011) are shown in greater detail in FIGS. 12-14 and in particular the fluted top surface (1012) of the bar (1011).

The linear corrugator (1001) has belt (1010) driven via the rotation of corrugating roller (1020) (via a motor not shown) such that the teeth of the roller (1021) engage with the flutes (1012) of the bars (1011) to move the belt (1010). In addition further motion can be imparted to the belt via toothed drive wheels (1015) are driven by a separate motor (not shown) so that the teeth (1016) may engage with pins connecting the bars (1011) through the gaps (1017) between laterally adjacent bars (1011) in the belt (1010). The gaps (1017) also facilitate the application of a vacuum through the conveyor in a similar manner to that already described above in relation to FIG. 5.

### Example 1

To calculate the rate of production for a 1.6 m diameter second corrugating (i.e. large) roller where the endless belt extends 76% around the second roller applying the new formula of the present invention RP=DHT/BT this equates to a RP (rate of production) of 0.76(π1.6)/0.05 which equals a rate of production of 76 m/min wherein 0.05 minutes is a 3 second bond time. This rate of production is significantly slower than that calculated by the applicant in WO2009/000085.

### Example 2

If a manufacturer requires a rate of production which is 143 m/min using an adhesive having a BT of 0.033333 min (i.e. 2 s) the diameter of the second corrugating (i.e. larger) roller applying the new formula of the present invention DHT can be represented as 0.93×(π2r) and the diameter can be calculated from DHT=RP·BT would be (143×0.033333). Then to get the diameter we rearrange the equation 0.93×(π2r)=(143×0.033333) so that 2r (i.e. the diameter)=((143×0.033333)/0.76)/n which equals a diameter of 2 m.

### Example 3

If we wanted to calculate the rate of production for a 2 m diameter roller wherein the BT is 0.05 min (i.e. 3 s). Applying the formula RP=DHT/BT 0.93(π2)/0.05 which equals 116 m/min.

In practice a diameter of 2 m is at or near the limit at which corrugated cardboard can be created via a pair of intermeshing corrugating rollers: such as described herein, shown in FIG. 2 or as described in the applicant's previous PCT Application WO2009/145642. One reason why in practice it is not possible to have a large corrugating roller with a diameter significantly larger than 2 m (for instance a 2.5 m, 3 m or greater diameter roller) is due to the increased weight of such a roller making it difficult to lift and move particularly when it comes to construction and maintenance and repair of such a large roller. Furthermore, the increased weight of a roller with a diameter greater than 2 m requires significantly more energy to rotate the roller and thus increases the cost of production. Moreover problems exist with maintaining a vacuum within such a large roller and again more energy is required to do this. For these reasons any increases in the rate of production achieved by a large corrugating roller having a diameter of greater than 2 m have been found by the applicant to be effectively negatived by the aforementioned problems.

### Example 4

A non-linear corrugator similar to that shown in FIG. 4 can produce single face corrugated board at faster rates than outlined in the above examples even though the bond times of the adhesive are the same. For example to have a rate of 200 m/min where the BT is 0.033333 minutes would require an endless slated conveyor overlapping with an endless tensioned belt assembly by a length of 6.6 m. According to the formula. RP=DHT/BT.

Aspects of the present invention have been described by way of example only and it should be appreciated that modifications and additions may be made thereto without departing from the scope of the appended claims.

1. A method of bonding a substantially planar sheet material to a corrugated sheet material both of which are porous using a continuous process, the method comprising:
a) applying a controlled amount of adhesive to an apex contact portion of the corrugated sheet material; and
b) holding the respective planar and corrugated sheets together at a specified pressure and for a specified pressing period so that a bond is formed between them.

2. The method as claimed in claim 1 wherein steps a) and b) are undertaken at an ambient temperature.

3. The method as claimed in claim 1 wherein the specified pressing period refers to the bond time (BT) calculated by the formula:
BT=DHT/RP
wherein RP is the rate of production in metres/minute and DHT is the distance in metres the two respective sheets are held together.

4. The method of bonding a substantially planar porous sheet material to a corrugated porous sheet material using a continuous process as claimed in claim 1 wherein the speed of production has been calculated by the formula:
RP=DHT/BT
wherein RP is the rate of production in metres/minute; DHT is the distance in metres for which the two respective sheets are held together; and BT is the bond time of the adhesive in minutes.

5. A method of manufacturing an apparatus having a large and small intermeshing corrugating rollers for continuously producing a single face porous sheet material comprising the step of using the formula:
RP=DHT/BT
to determine the diameter of the large corrugating roller and percentage of the circumference of the large corrugating roller about which an endless belt assembly needs to apply pressure so as to achieve the desired rate of production;
wherein RP is the rate of production in metres/minute; DHT is the distance in metres for which the two respective sheets are held together; and BT is the bond time of the adhesive in minutes.

6. An apparatus which bonds substantially planar porous sheet material to corrugated porous sheet material, to produce a single face corrugated porous sheet material as part of a continuous process, said apparatus comprising: a large corrugating roller and a smaller corrugator roller and glue applicator assembly together with an endless tensioned belt, wherein the rate of production of the apparatus has been determined by the formula:
RP=DHT/BT
wherein RP is the rate of production in metres/minute; DHT is the distance in metres the two respective sheets are held together; and BT is the bond time of the adhesive in minutes.

7. An apparatus which bonds a substantially planar porous sheet material to a corrugated porous sheet material, to produce a single face corrugated porous sheet material via a continuous process, wherein the apparatus comprises: a large diameter corrugating roller intermeshing with a smaller diameter corrugating roller, and an endless tensioned belt assembly arranged to apply pressure over the circumferential surface of the large corrugating roller to facilitate lamination of the planar and corrugated sheets, wherein the circumference of the large diameter corrugating roller about which the endless belt can apply tension is governed by the formula:
C=(RP·BT)/X
wherein C is the circumference of the roller (i.e. π2r); RP is the rate of production in metres/minute and BT is the bond time in minutes; and X is maximum percentage of the circumference about which pressure can be applied by the endless tensioned belt.

8. An apparatus which bonds a substantially planar porous sheet material to a corrugated porous sheet material to form single face corrugated porous sheet material via a continuous process, comprising: a large diameter corrugating roller intermeshing with a smaller diameter corrugating roller, and a endless tensioned belt assembly which includes a tensioned belt arranged to apply pressure over the circumference of the large corrugating roller to facilitate lamination of the planar and corrugated sheets wherein the percentage of the circumference of the large corrugating roller which does not have the tensioned belt applying pressure thereto is limited solely by the minimum relative space required for the smaller corrugating roller and glue applicator assembly.

9. A method of operating a large diameter corrugating roller intermeshing with a smaller diameter corrugating roller and an endless tensioned belt comprising: a pressing step in which the tensioned belt is arranged to apply pressure over a portion of the circumferential surface of the large corrugating roller to form an adhesive bond between a substantially planar porous sheet material and a corrugated porous sheet material, and including the further step of using the percentage of belt span about the circumference of a larger corrugating roller to determine the rate of production.

10. A method of using a tensioned belt and a large diameter corrugating roller intermeshing with a smaller diameter corrugating roller and glue applicator assembly to produce single face corrugated board from a porous planar sheet material and planar corrugated sheet material, the method comprising: applying an adhesive to the corrugated sheet material, at an ambient temperature, and then holding the respective planar and corrugated sheets together via the tensioned belt, for a specified period of time.

11. The method as claimed in claim 1 further including providing a large corrugating roller and an endless tensioned belt wherein the maximum rate of production is determined by the formula:
RP=X(π2r)·BT
wherein RP is the rate of production in metres/minute, BT is the bond time in minutes, and X is the percentage of the circumference of the large corrugating roller about which pressure is applied by the endless tensioned belt.

12. The method as claimed in claim 10 wherein the maximum rate of production is determined by the formula:
RP=X(π2r)·BT
wherein RP is the rate of production in metres/minute, BT is the bond time in minutes, and X is the percentage of the circumference of the large corrugating roller about which pressure is applied by the endless tensioned belt.

13. The apparatus as claimed in claim 7 wherein the endless tensioned belt is configured so the belt can apply pressure over 70%-93% of the circumference of the large corrugating roller.

14. A method of bonding a substantially planar sheet material to a corrugated sheet material both of which are porous using an automated process, the method comprising:
a) applying adhesive to the corrugated sheet material with a glue application (GA) roller which has lateral left to right grooves about the GA roller's circumference which engage with teeth on the corrugating roller wherein said grooves in the GA roller hold a set amount of glue therein
b) holding the respective planar and corrugated sheets together at a specified pressure and for a specified time so a bond is formed there between.

15. The method of bonding as claimed in claim 14 wherein the dimensions of the grooves on the GA roller enable
a line of adhesive to be held therein;
the teeth (or a portion thereof) on the corrugating roller and apex contact portion of the corrugated sheet to be received therein;
such that a line of adhesive can be applied to the apex contact portions of the corrugated sheet.

16. An apparatus for making single face corrugated board by bonding a corrugated sheet material having one or more crests onto a substantially planar sheet, both of which are porous, the apparatus comprising:
an applicator configured to apply adhesive to each crest of the corrugated sheet material, and
a pressing mechanism for pressing the planar sheet against the crest of the corrugated material
wherein the applicator is configured to apply a controlled amount of adhesive to apex contact portions on each crest of the corrugated sheet material, and wherein the pressing mechanism is configured to press the planar sheet material against the corrugated sheet material at a specified pressure for a specified time so a bond is formed there between.

17. An apparatus which bonds substantially planar porous sheet material to a corrugated sheet material via a continuous process, wherein the apparatus comprises a large corrugating roller which intermeshes with a small corrugating roller, wherein the diameter of the smaller roller is at least substantially between 0.16 m-0.2 m diameter and the large corrugating roller has a diameter of at least substantially between 0.4 m-2.0 m.

18. The apparatus as claimed in claim 8 wherein the apparatus operates at a maximum rate of production determined by the formula:
RP=X(π2r)·BT
wherein RP is the rate of production in metres/minute, BT is the bond time in minutes, and X is the percentage of the circumference of the large corrugating roller about which pressure can be applied by an endless tensioned belt.

19. A use of the principle:
RP=DHT/BT
in the construction of a single face paperboard manufacturing facility;
wherein RP is the rate of production in metres/minute; DHT is the distance in metres for which the two respective sheets are held together; and BT is the bond time of the adhesive in minutes.

20. A use of a water-based adhesive in the production of single face paperboard.

21. The use of claim 20 wherein the adhesive is a dispersion containing vinyl acetate copolymer.

22. An apparatus for manufacturing a single face corrugated sheet of porous material via an automated process wherein the apparatus comprises:
a corrugating roller;
a contoured roller to apply discrete droplets of glue to the crests of freshly corrugated sheet material.
an endless fluted conveyor belt assembly having an endless fluted conveyor surface including a plurality of adjacent flutes wherein the flutes are configured to correspond to the teeth on the corrugating roller.
a pressure mechanism configured to hold freshly corrugated sheet material to the fluted conveyor surface whilst adhesive is applied by a glue applicator;
an endless tensioned belt assembly which holds planar sheet material and the corrugated sheet material together so a bond is formed there between; wherein the pressure mechanism is in the form of a vacuum pump and wherein the vacuum pump is positioned solely the front end of the endless fluted conveyor assembly.

23. An apparatus for manufacturing double face corrugated board via a continuous in-line automated process wherein the apparatus comprises:
i) a single face corrugator module comprising:
a corrugating roller;
an endless fluted conveyor belt assembly having an endless fluted conveyor surface including a plurality of adjacent flutes wherein the flutes are configured to correspond to the teeth on the corrugating roller;
a pressure mechanism configured to hold freshly corrugated sheet material to the fluted conveyor surface whilst adhesive is applied by a glue applicator; wherein the pressure mechanism is in the form of a vacuum pump and wherein the vacuum pump is positioned solely the front end of the endless fluted conveyor assembly;
wherein the module is configured so that sheet material passing between the respective intermeshing teeth on the corrugating roller and endless fluted conveyor belt assembly becomes corrugated and is subjected to a first pressure mechanism before contacting a glue applicator in the form of a contoured roller and coming into contact with planar sheet material and a second pressure mechanism in the form of an endless tensioned belt assembly which holds the respective planar and corrugated sheets together so a bond is formed there between;
ii) a laminator module comprising:
two vertically opposed endless linear tensioned belt assemblies which receive there between:
a) planar sheet material; and
b) single face corrugated sheet material from the corrugator module
wherein a glue applicator in form of a contoured roller applies adhesive to the single face corrugated board and/or planar sheet material prior to entering the opposed endless tensioned belt assemblies which hold the planar sheet material and single face corrugated board together so a bond is formed there between.

24. A method of bonding for use in the manufacture of single face or double face corrugated board, both of which are porous comprising: using an arrangement of at least one endless linear tensioned belt assembly and one endless slatted conveyor assembly to hold corrugated sheet material together with planar sheet material so a bond is formed there between.

25. The method as claimed in claim 24 wherein the corrugated sheet material and planar sheet material are held together for a specified pressing time calculated by the formula:
BT=DHT/RP
wherein RP is the rate of production in metres/minute; DHT is the distance in metres the two respective sheets are held together; and BT is the bond time in minutes of the adhesive used and this determines the pressing period.

26. A corrugated sheet material produced by the method of claim 1.
